(19) United States
(12) Patent Application Publication
(10) Pub. No.: US 2006/0120878 A1
(43) Pub. Date: Jun. 8, 2006

(54) Magnetofluiddynamic pumps for non-conductive fluids

(75) Inventors: Uttam Ghoshal, Austin, TX (US); Andrew Carl Miner, Austin, TX (US); Key Kolle, Luling, TX (US)

Correspondence Address: ZAGORIN O'BRIEN GRAHAM LLP, 7600B N. CAPITAL OF TEXAS HWY., SUITE 350, AUSTIN, TX, 78731, US

(73) Assignee: NanoCoolers, Inc.

(21) Appl. No.: 11/236,436

(22) Filed: Sep. 27, 2005

Related U.S. Application Data
(63) Continuation of application No. PCT/US04/16018, filed on May 21, 2004.
(63) Continuation-in-part of application No. 10/443,186, filed on May 22, 2003.

(51) Int. Cl. F04B 37/02; H02K 44/00

(52) U.S. Cl. 417/48; 417/50

(57) ABSTRACT

A magnetofluiddynamic (MFD) pump including a liquid (or partially liquid) piston and at least two valve-delimited chambers is disclosed. The valve-delimited chambers may be coupled, in series or parallel, between the input and the output of a fluid passage to provide either intermittent flow of the working fluid or substantially continuous working fluid flow. In at least one embodiment, a piston chamber housing a conductive liquid (e.g. liquid) piston is coupled to two valve-delimited chambers so that a single stroke of the piston both draws working fluid into one of the chambers and pushes working fluid out of the other chamber.

### CROSS-REFERENCE TO RELATED APPLICATION(S)

This application is a continuation of commonly-owned, co-pending international application PCT/US04/16018, filed 21 May 2004. This application is also a continuation-in-part of commonly-owned, co-pending U.S. application Ser. No. 10/443,186, filed 22 May 2003.

### BACKGROUND

1. Field of the Invention

The present invention relates to applications of magnetofluiddynamic (MFD) pumps. More particularly, it relates to the use of MFD pumps for pumping of non-conductive (e.g., dielectric) fluids.

2. Description of the Related Art

Electronic devices such as central processing units, graphic-processing units and laser diodes as well as electrical devices, such as transformers, generate a lot of heat during operation. If generated heat is not dissipated properly from high power density devices, this may lead to temperature buildup in these devices. The buildup of temperature can adversely affect the performance of these devices. For example, excessive temperature buildup may lead to malfunctioning or breakdown of the devices. So, it is important to remove the generated heat in order to maintain normal operating temperatures of these devices. A number of cooling systems have been proposed for the removal of the generated heat, some of which involve single phase cooling using a pump for controlling the flow of a liquid metal coolant.

Some MFD pumps can attain high mass flow rates (˜50 g/s in miniature pumps) at sub-1W power dissipation levels. The excellent fluid flow characteristics combined with high thermal conductivities of liquid metals can result in improved extraction of heat from the source and improved rejection in the ambient heat exchanger.

However, in some applications, the advantages offered by using liquid metal are offset by other considerations such as the high volume, high weight and high electrical conductivity of the liquid metal. For example, in portable systems such as laptops and notebooks, the high volume and weight of liquid metals is a restriction on their use as coolants. Moreover, in case of cooling of high voltage power supplies and transformers, the use of electrically conductive liquid metals may not be recommended. For such applications, non-conductive fluids such as water may be used. Further, two-phase cooling may be employed so as to benefit from the high latent heat of vaporization of the coolants. One such two-phase cooling system is illustrated in FIG. 1. The two-phase cooling system is used for cooling a hot source 102. Hot source 102 may be a microelectronic chip, an optoelectronic chip, a laser diode, a light emitting diode (LED), a high voltage power supply, a central processing unit of a computer etc. A coolant 104 present in evaporator 106 is vaporized on the surface of hot source 102, resulting in the extraction of heat from hot source 102. The vapor so formed is transferred to a condenser 108 that rejects heat to the ambient atmosphere and liquefies the vapor. The coolant so formed is re-circulated over hot source 102 with the help of a pump 110.

Pump 110 may be a conventional pump. However, MFD pumps are more reliable and safe compared to other pumps, as MFD pumps do not have mobile parts (with the exception of the conductive fluid itself). Therefore, an MFD pump may be used so as to benefit from the advantages offered by an MFD pump over a conventional pump. However, an MFD pump needs to be adapted for the purpose of pumping a non-conductive fluid.

One adaptation of an MFD pump is discussed in U.S. Pat. No. 6,241,480, titled “Micro-Magnetohydrodynamic Pump And Method For Operation Of The Same”. The patent discloses a system in which a valving liquid metal piston and a pumping liquid metal piston are used for pumping fluids. A single valving piston regulates the flow of fluid in and out of the system, while the pumping liquid metal piston enables the suction and pumping of the fluid in response to a series of piston strokes. Both the liquid metal pistons are driven magnetohydrodynamically in an oscillatory manner (the direction of motion of the pistons is varied periodically). However, this system suffers from certain disadvantages. Firstly, the movement of the two liquid metal pistons has to be synchronized for proper functioning. Secondly, the system produces discontinuous outflow of the fluid since the outflow is restricted to half the oscillatory cycle of the pistons (in one particular embodiment, fluid is pumped out only when the valving piston moves to the left and the pumping piston moves up, and not in the reverse movement). Thirdly, the valve action is based on the surface tension properties of liquid metals resulting in poor pressure heads and poor mean time between failures (MTBF).

Hence, there is a need for an improved pump for fluid pumping applications.

### SUMMARY

Various embodiments of magnetofluiddynamic (MFD) pumps and pumping systems are disclosed herein. An MFD pump according to at least one embodiment of the invention employs a piston that is at least partially made up of one or more fluids. In some embodiments, the piston is a completely (or almost completely) liquid piston made up of one or more liquid metals, liquid metal alloys, or some combination of other conductive liquids. In some embodiments, the piston includes a rod, plug, disk, ball, or other mass of conductive material at least partially surrounded by a conductive liquid. In some embodiments, the piston includes a conductive slurry, or some similar combination of solids and liquids that permits the piston to be driven using a magnetic field in conjunction with an electric current passing through the piston.

Various embodiments of an MFD pump according to the present invention include a working fluid passage having multiple valve-delimited chambers coupled between an input and an output of the working fluid passage. In some embodiments, one-way valves are used to provide working fluid flow into one chamber and out of another chamber during a single stroke of the piston. In one such embodiment, two valve-delimited chambers are coupled in series with each other, so that working fluid is pushed out of the pump during alternate strokes. Other embodiments provide for two or more of the valve-delimited chambers to be coupled in parallel, so that a working fluid is pushed out of the pump during successive piston strokes.

Some embodiments provide cooling systems including an MFD pump. At least one such embodiment uses the MFD pump as a compressor in a cooling system, e.g. a two-phase cooling system, suitable for use in portable systems such as laptop computers. Such a cooling system may also be used in other, non-portable systems. A pump according to at least one embodiment of the present invention may also find application in high voltage systems, or other systems that may benefit from use of non-conductive coolants.

### BRIEF DESCRIPTION OF THE DRAWINGS

The present invention may be better understood, and its numerous objects, features, and advantages made apparent to those skilled in the art by referencing the accompanying drawings.

FIG. 1 is a block diagram of a two-phase cooling system.

FIG. 2 illustrates a fluid pump in accordance with some embodiments of the present invention.

FIG. 3 illustrates a fluid pump in accordance with some embodiments of the present invention.

FIG. 4 illustrates a fluid pump in accordance with some embodiments of the present invention.

FIG. 5 illustrates a fluid pump in accordance with some embodiments of the present invention.

FIG. 6 is a block diagram of a vapor compression system including a fluid pump according to some embodiments of the present invention.

The use of the same reference symbols in different drawings indicates similar or identical items.

### DESCRIPTION OF THE PREFERRED EMBODIMENT(S)

At least one embodiment of the present invention provides a magnetofluiddynamic (MFD) pump for pumping of working fluids. More particularly, certain embodiments of the invention provide a pump for pumping of non-conductive fluids using a magnetofluiddynamic (MFD) pump having a piston that includes liquid.

A pump according to an embodiment of the invention combines one-way fluid flow valves with a liquid piston, reciprocating MFD pump. The liquid piston may be almost completely liquid, primarily liquid, a primarily solid core surrounded by liquid, a slurry, or some combination thereof. In at least one embodiment all or a portion of the piston includes a conductive liquid, such as a liquid metal or a liquid metal alloy. The valves in at least one embodiment have a diodicity greater than one, and are used to provide direction to the flow of working fluid through the pump. The MFD pump, which in at least one embodiment employs a true (zero crossing) alternating current (AC) is passed through the piston to generate a Lorentz force that drives the piston in a reciprocating manner, the motion of the liquid piston enabling the suction and pumping of the working fluid through the MFD pump. In other embodiments a pulsed or switched DC current, or some other suitable current is passed through the piston to generate the Lorentz force used to drive the piston. The description employs the term magnetofluiddynamic (MFD) or magnetohydrodynamic (MHD) in describing operation of various pump configurations. While MHD and MFD may, in some cases be used interchangeably, in describing some configurations in which the Lorentz-force-driven fluid need not be water or water-based we use the potentially more general term MFD for clarity.

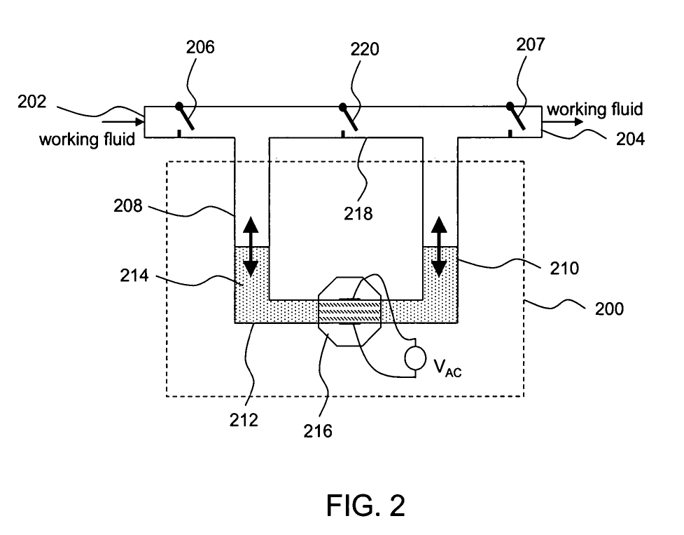

Referring now primarily to FIG. 2, the structure of an exemplary pump in accordance with a first embodiment of the present invention will hereinafter be described. The pump in accordance with the first embodiment includes a suction and pumping assembly 200 for sucking and pumping the working fluid, an inlet conduit 202 for allowing inflow of the working fluid, an outlet conduit 204 for allowing outflow of the working fluid and a valve 206 in inlet conduit 202 and a valve 207 in outlet conduit 204.

Suction and pumping assembly 200 comprises three hollow chambers—a first (left) vertical chamber 208, a second (right) vertical chamber 210 and an intermediate horizontal chamber 212. First vertical chamber 208 and second vertical chamber 210 are both partially filled with a liquid metal 214. Intermediate horizontal chamber 212 is completely filled with liquid metal 214. Liquid metal 214 is driven in an oscillatory manner by an AC-powered reciprocating MFD pump 216 connected to intermediate horizontal chamber 212.

Inlet conduit 202 is connected to first vertical chamber 208 and outlet conduit 204 is connected to second vertical chamber 210. Moreover, first vertical chamber 208 and second vertical chamber 210 are connected through an intermediate conduit 218 to enable the transfer of the working fluid. Intermediate conduit 218 has a valve 220 for ensuring the unidirectional transfer of the working fluid from first vertical chamber 208 to second vertical chamber 210.

The working fluid is sucked into first vertical chamber 208 through inlet conduit 202, transferred to second vertical chamber 210 through intermediate conduit 218 and pumped out through outlet conduit 204. The suction, transfer and pumping of the working fluid is achieved by the oscillatory motion of liquid metal 214. This oscillatory motion of liquid metal 214 is governed by cycles of the AC supply that drives AC-powered reciprocating MFD pump 216.

During one half of the AC cycle, liquid metal 214 in first vertical chamber 208 is driven down. As a result, the working fluid is sucked into first vertical chamber 208 through inlet conduit 202. During the same AC cycle, the working fluid already in second vertical chamber 210 is pumped out through outlet conduit 204. Valve 220 ensures that the working fluid is not transferred from second vertical chamber 210 to first vertical chamber 208 during this cycle.

During the other half of the AC cycle, liquid metal 214 in first vertical chamber 208 is driven up. As a result, the working fluid is transferred from first vertical chamber 208 to second vertical chamber 210 through intermediate conduit 218. Valve 206 ensures that the working fluid is not pumped out of first vertical chamber 208 through inlet conduit 202 in this cycle. Valve 207 ensures that the working fluid is not sucked into second vertical chamber 210 through outlet conduit 204 in this cycle.

This embodiment results in a half-rectified (discontinuous) flow of the working fluid, with the outflow and inflow of the working fluid being synchronized.

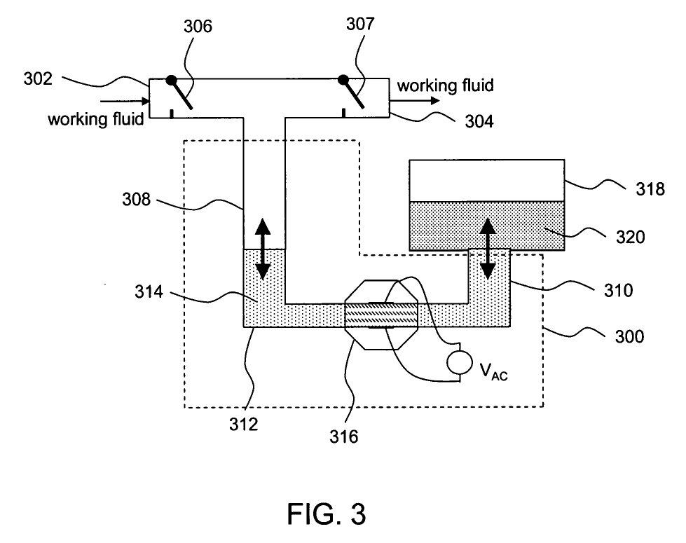

Referring now primarily to FIG. 3, the structure of a pump in accordance with an embodiment of the present invention will hereinafter be described. The pump in accordance with the second embodiment comprises a suction and pumping assembly 300 for sucking and pumping the working fluid, an inlet conduit 302 for allowing the inflow of the working fluid, an outlet conduit 304 for allowing the outflow of the working fluid and a valve 306 in inlet conduit 302 and a valve 307 in outlet conduit 304.

Suction and pumping assembly 300 comprises three hollow chambers—a first vertical chamber 308, a second vertical chamber 310 and an intermediate horizontal chamber 312. First vertical chamber 308 is partially filled and second vertical chamber 310 is completely filled with a liquid metal 314. Intermediate horizontal chamber 312 is completely filled with liquid metal 314. Liquid metal 314 is driven in an oscillatory manner by an AC-powered reciprocating MFD pump 316 connected to intermediate horizontal chamber 312.

Inlet conduit 302 and outlet conduit 304 are both connected to first vertical chamber 308. Second vertical chamber 310 is connected to a reservoir 318 filled with an inert fluid 320. Inert fluid 320 may be any fluid that does not react with liquid metal 314 and prevents surface oxidation. Examples of such fluid include Fluorinert and weakly acidic water with pH between 3 and 4.

The working fluid is sucked into first vertical chamber 308 through inlet conduit 302 and pumped out through outlet conduit 304. The suction and pumping of the working fluid is achieved by the oscillatory motion of liquid metal 314. This oscillatory motion of the liquid metal 314 is governed by cycles of the AC supply that drives AC-powered reciprocating MFD pump 316.

During one half of the AC cycle, liquid metal 314 in first vertical chamber 308 is driven down. As a result, the working fluid is sucked into first vertical chamber 308 through inlet conduit 302. Valve 307 ensures that the working fluid is not sucked into first vertical chamber 308 through outlet conduit 304 during this cycle.

During the other half of the AC cycle, liquid metal 314 in first vertical chamber 308 is driven up. As a result, the working fluid is pumped out through outlet conduit 304. Valve 306 ensures that the working fluid is not pumped out of first vertical chamber 308 through inlet conduit 302 during this cycle.

Hence, this embodiment results in a half-rectified (discontinuous) flow of the working fluid, with the inflow and outflow of the working fluid being out of phase.

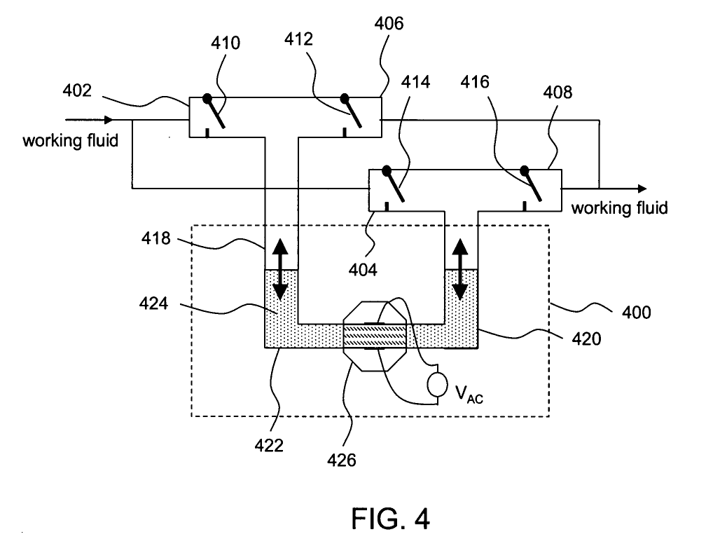

Referring now primarily to FIG. 4, the structure of a pump in accordance with an embodiment of the present invention will hereinafter be described. The illustrated apparatus includes a suction and pumping assembly 400 for sucking and pumping the working fluid, two inlet conduits 402 and 404 for the inflow of the working fluid, two outlet conduits 406 and 408 for the outflow of the working fluid and four valves 410, 412, 414 and 416, one in each conduit.

Suction and pumping assembly 400 comprises three hollow chambers—a first vertical chamber 418, a second vertical chamber 420 and an intermediate horizontal chamber 422. First vertical chamber 418 and second vertical chamber 420 are both partially filled with a liquid metal 424. Intermediate horizontal chamber 422 is completely filled with liquid metal 424. Liquid metal 424 is driven in an oscillatory manner by an AC-powered reciprocating MFD pump 426 connected to intermediate horizontal chamber 422.

Inlet conduit 402 and outlet conduit 406 are connected to first vertical chamber 408. On the other hand, inlet conduit 404 and outlet conduit 408 are connected to second vertical chamber 420.

The working fluid is sucked into either first vertical chamber 418 through inlet conduit 402 or into second vertical chamber 420 through inlet conduit 404. Thereafter, the working fluid is pumped out of the same chamber it was sucked into, through either outlet conduit 406 or outlet conduit 408. For example, in case the working fluid is sucked into first vertical chamber 418, it will be pumped out of the same chamber through outlet conduit 406. The suction, transfer and pumping of the working fluid is achieved by the oscillatory motion of liquid metal 424. This oscillatory motion of liquid metal 424 is governed by cycles of the AC supply that drives AC-powered reciprocating MFD pump 426.

During one half of the AC cycle, liquid metal 424 in first vertical chamber 418 is driven down. As a result, the working fluid is sucked into first vertical chamber 418 through inlet conduit 402. The downward motion of liquid metal 424 in first vertical chamber 418 causes an upward motion of liquid metal 424 in second vertical chamber 420. This causes the working fluid in this chamber to be pumped out through outlet conduit 408. Valve 412 ensures that the working fluid is not sucked into first vertical chamber 418 through outlet conduit 406 during this cycle. Moreover, valve 414 ensures that the working fluid is not pumped out of second vertical chamber 420 through inlet conduit 404 during this cycle.

During the other half of the AC cycle, liquid metal 424 in first vertical chamber 418 is driven up. As a result, the working fluid is pumped out of first vertical chamber 418 through outlet conduit 406. The upward motion of liquid metal 424 in first vertical chamber 418 causes a downward motion of liquid metal 424 in second vertical chamber 420. This causes the working fluid to be sucked in to second vertical chamber 420 through inlet conduit 404. Valve 410 ensures that the working fluid is not pumped out of first vertical chamber 418 through inlet conduit 402 during this cycle. Moreover, valve 416 ensures that the working fluid is not sucked into second vertical chamber 420 through outlet conduit 408 during this cycle.

This embodiment results in a fully rectified (almost continuous) flow of the working fluid.

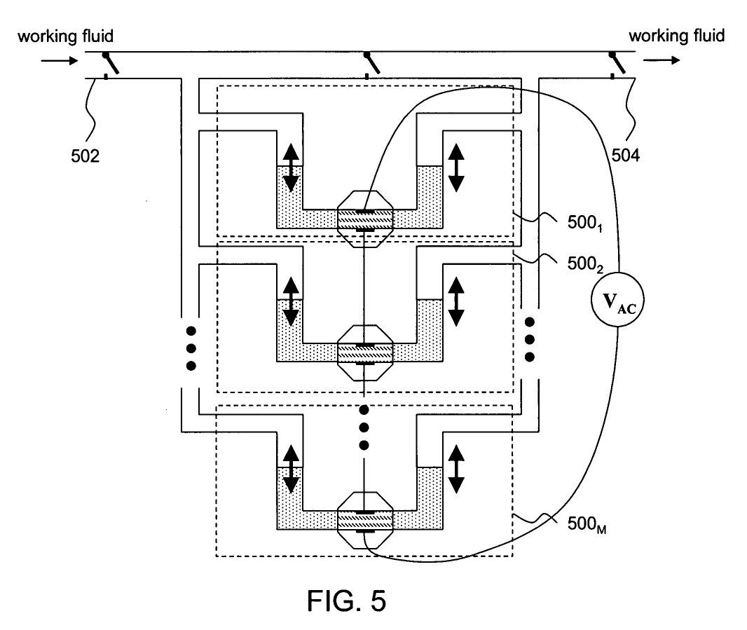

In some embodiments of the present invention, suction and pumping assemblies, in accordance with any of the previously discussed embodiments, are combined in parallel. Such a structure results in an increase in the pumping capacity and pressure head. This results in an increase in the power of the pump. Referring now primarily to FIG. 5, an exemplary structure of one such pump will hereinafter be described. Suction and pumping assemblies 500₁ to 500_{M}, corresponding to the first embodiment of the pump (shown in FIG. 2), are combined in parallel. The working fluid flows into suction and pumping assemblies 500₁ to 500_{M} through an inlet conduit 502 and is pumped out through an outlet conduit 504.

The operating voltage of the pump provided by this embodiment is proportional to the number of suction and pumping assemblies connected in parallel. This provides flexibility for increasing the operating voltage of the pump. Higher operating voltage may be desirable in some cases due to the following reason.

Conventional pumps operate at a voltage of <20 mV. On the other hand, voltages provided by typical power supplies are of the order of 5-100V. This requires the downconversion of the supply voltage to the low operating voltage of the pump. The efficiency of downconversion becomes smaller (<90%) for voltage downconversion ratios>100. The size of the downconverting circuit also becomes large when the voltage downconversion ratios are large. The above-mentioned embodiment allows operation at increased voltages and lower voltage downconversion ratios.

In the embodiments of the present invention, the suction and pumping assembly has been shown as a U-shaped structure. It will be apparent to one skilled in the art that the suction and pumping assembly can have other similar shapes including but not limited to a distorted U-shape (where the angles between the horizontal intermediate chamber and the first and second vertical chambers are different from 90°). Furthermore, terms such as “vertical” and “horizontal” are used solely as a descriptive frame of reference and do not constitute an orientation requirement. Other configurations, including generally linear MFD drive fluid chambers are possible.

In the above-mentioned embodiments of the present invention, one-way moving valves such as ball and cage valves and flapper valves may be used. Alternatively, non-moving valves such as Tesla valves may be used. U.S. Pat. No. 6,227,809 titled “Method For Making Micropump” describes the use of non-moving valves in miniature pumps. The valves used in some of the abovementioned embodiments, do not necessarily need external control i.e. their operation may depend on the pressure differences across the valve.

Such valves facilitate directional flow of working fluid through the pump when the valves have a diodicity greater than one, resulting in fluid flow through the valves primarily in a preferred direction, even if some backflow occurs. For example, a valve having a diodicity of 1.1 would result in slightly more fluid flowing in a preferred direction, with a relatively significant amount of backflow (e.g. leaky valves). A valve having a diodicity of 5 would result in substantially more fluid flow in the preferred direction, with much less backflow than occurs with the valve having a diodicity of 1.1.

A number of different liquid-metal drive-fluids may be used in the above-mentioned embodiments without departing from the scope of the invention. For example, liquid metals having high thermal conductivity, high electrical conductivity and high volumetric heat capacity can be used. Some examples of liquid metal that can be used in the above-mentioned embodiments include: sodium potassium eutectic alloy, gallium-indium alloy, mercury, bismuth, indium and gallium. Also, a number of working fluids can be used in the invention. In general, the working fluid should not react with the drive fluid (particularly gallium-based drive fluids) form oxides or any compound that result in long term fouling. Typical examples of such working fluids include slightly acidic water with pH between 3 and 4, fluorinerts, CFCs, R134a, and Puron. The pumps can also be used for pumping air if the surface of liquid metal is covered with inert fluid or nitrogen or any inert gas. The chambers of the suction and pumping assembly as well as the inlet and outlet conduits can be constructed of polymer materials such as Teflon or polyurethane. Tungsten or nickel-coated copper can be used as electrodes.

A pump provided by some embodiments of the present invention delivers maximum power efficiency at an optimal resonant frequency. This optimal resonant frequency in turn depends on factors such as the volume of the working fluid transferred between the first and second chambers, the external pressure head, length of the chambers and the diodicity (flow to leakage ratio) of the valves. For example, for a pump with 1-2 cm³ of working fluid with density of 1-2 g/cc, the optimal resonant frequency is in the range of 1-30 Hz, the exact value depending on the other factors.

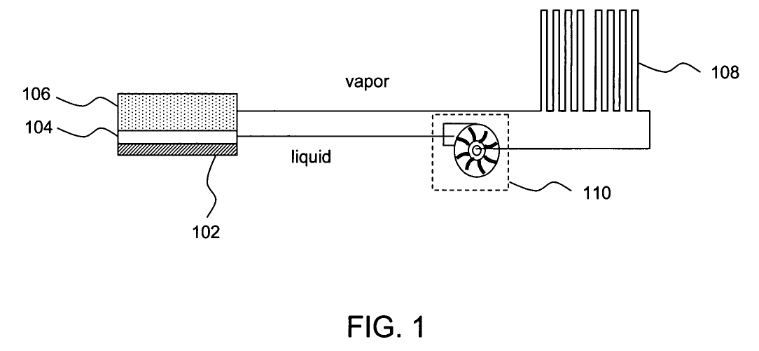

Referring back to FIG. 1, an application of the present invention will hereinafter be discussed. As described previously, FIG. 1 shows a general two-phase cooling system. A pump provided by the present invention is used in such a two-phase cooling system as pump 110. In some embodiments of a system provided by the present invention, Fluorinert is used as the coolant, i.e., as a working fluid. Fluorinert is a colorless, fully fluorinated liquid such as Fluorinert™ Electronic Liquid FC-72 provided by 3M.

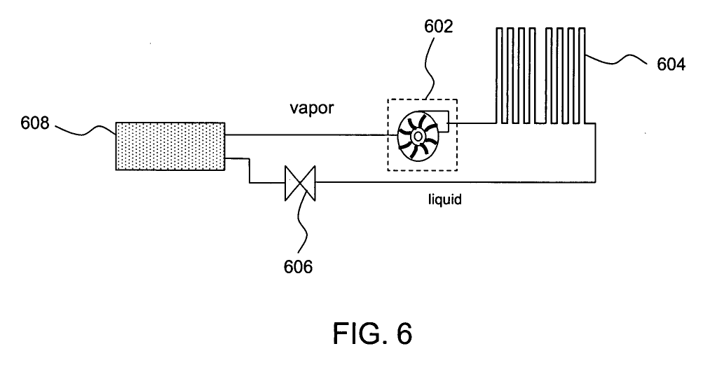

A pump provided by the present invention can also be used as a vapor compressor. Referring now primarily to FIG. 6, an application of the pump as a vapor compressor will hereinafter be discussed. FIG. 6 shows a vapor compression system, commonly used in air-conditioners and refrigerators. A refrigerant fluid such as R134a is converted from a low pressure vapor state to a high pressure fluid by a compressor 602. The high pressure fluid is cooled at a condenser 604 by rejecting the heat to the ambient atmosphere. The high pressure is next released through an expansion valve 606 to a cold end chamber or evaporator 608. The expansion results in cooling of the fluid and subsequent extraction of heat from the walls of cold end chamber or evaporator 608. This low-pressure refrigerant is re-circulated into compressor 602. At least one embodiment of the present invention includes a vapor compression system, such as compressor 602.

Various embodiments of the present invention offer several advantages over more conventional systems. Firstly, the use of high reliability valves such as ball and cage valves and Tesla valves may result in improved fluid flow performance. Secondly, various embodiments of the present invention are capable of providing a variety of fluid flow profiles (both continuous and discontinuous flow). Thirdly, a pump, as described herein, can be constructed to have low weight and volume, and is thus suitable for use in portable systems. Fourthly, an MFD pump has fewer moving parts than many conventional pumps, and may thus safer and more reliable. Finally, a pump as described herein is suitable for use in high-voltage systems due to its ability of pumping non-conductive fluids.

While various embodiments of the invention have been illustrated and described in some detail, it will be appreciated that the invention is not limited to the described embodiments only. Numerous modifications, changes, variations, substitutions and equivalents will be apparent to those skilled in the art without departing from the spirit and scope of the invention as described in the claims.

What is claimed is:

1. A pump comprising:
a fluid passage including
an input to receive a working fluid;
an output to discharge the working fluid; and
two valve-delimited chambers coupled therebetween;
a piston chamber coupled to the valve-delimited chambers; and
a magnetofluiddynamic (MD) pump to drive a piston comprising liquid, wherein a single stroke of the piston draws working fluid into one of the two chambers and pushes working fluid out of the other of the two chambers.

2. The pump of claim 1,
wherein a first one of the valve-delimited chambers is coupled in series with the second one of the valve-delimited chambers.

3. The pump of claim 2,
wherein the two valve-delimited chambers share at least one valve.

4. The pump of claim 1,
wherein the two valve-delimited chambers are coupled in parallel to each other.

5. The pump of claim 1,
wherein said piston comprises a liquid metal.

6. The pump of claim 1,
wherein the piston further comprises a conductive solid portion disposed within the liquid.

7. The pump of claim 1,
wherein the piston consists entirely of liquid.

8. The pump of claim 1, further comprising:
at least a third valve delimited chamber coupled between the input and the output.

9. The pump of claim 1,
wherein the working fluid is non-conductive.

10. The pump of claim 1,
wherein the pump is configured in a compressor configuration; and
wherein the working fluid is a two-phase fluid.

11. The pump of claim 1, further comprising:
at least one additional MFD pump.

12. A method comprising:
electromagnetically driving a piston comprising conductive liquid to draw working fluid into a first valve-delimited chamber and to push working fluid out of a second valve-delimited chamber during a single stroke of the piston.

13. The method of claim 12,
wherein the electromagnetically driving includes passing an alternating current through the piston to impart a reciprocating motion to the piston.

14. The method of claim 12,
wherein the piston includes a conductive solid portion disposed within the conductive liquid.

15. The method of claim 12,
wherein the piston consists entirely of the conductive liquid.

16. The method of claim 12,
wherein the conductive liquid includes a liquid metal.

17. The method of claim 12,
wherein the first valve-delimited chamber and the second valve-delimited chamber are coupled between an input and an output of a fluid passage; and
wherein pumping the working fluid includes discharging a volume of working fluid from the output of the fluid passage during alternate strokes of the piston.

18. The method of claim 12,
wherein the first valve-delimited chamber and the second valve-delimited chamber are coupled between an input and an output of a fluid passage; and
wherein pumping the working fluid includes discharging a volume of working fluid from the output of the fluid passage during each stroke of the piston.

19. The method of claim 12,
wherein the working fluid is non-conductive.

20. A system comprising:
a heat sink to receive heat from a heat source;
a heat dissipater in fluid communication with said heat sink; and
a magnetofluiddynamic (MFD) pump including a piston comprising liquid to circulate a working fluid through said heat sink and said heat dissipater, wherein a single stroke of the piston draws working fluid into at least a first of a plurality of valve-delimited chambers disposed in a path of the working fluid and pushes working fluid out of at least a second of the plurality of valve-delimited chambers.

21. The system of claim 20,
wherein said heat sink includes an evaporator; and
wherein said heat dissipater includes a condenser.

22. The system of claim 20,
wherein said MFD pump is further to receive the working fluid as a vapor at an input of the MFD pump and discharge the working fluid as a liquid at an output of the MFD pump.

23. The system of claim 22, further comprising:
an expansion valve.

24. The system of claim 20,
wherein said piston comprises a liquid metal.

25. The system of claim 20,
wherein said piston further comprises a conductive solid portion disposed within the liquid.

26. The system of claim 20,
wherein said piston consists substantially entirely of liquid.

27. The system of claim 20,
wherein said MFD pump is configured to produce an intermittent flow of working fluid.

28. The system of claim 20,
wherein said MFD pump is configured to produce a fully rectified flow of working fluid.

29. A method comprising:
circulating a coolant past a device to be cooled using a magnetofluiddynamic pump employing a piston comprising a liquid, wherein a single stroke of the piston draws coolant into at least a first of a plurality of valve-delimited chambers disposed in a path of the coolant and pushes coolant out of at least a second of the plurality of valve-delimited chambers.

30. The method of claim 29,
wherein said piston comprises a liquid metal.

31. The method of claim 29,
wherein said piston further comprises a conductive solid portion disposed within the liquid.

32. The method of claim 29,
wherein said piston consists substantially entirely of liquid.

33. The method of claim 29,
wherein the circulating includes impelling the coolant out of the pump during alternate strokes of the piston.

34. The method of claim 29,
wherein the circulating includes impelling the coolant out of the pump during successive strokes of the piston.
